(19) United States
(12) Patent Application Publication
(10) Pub. No.: US 2020/0153889 A1
(43) Pub. Date: May 14, 2020

(54) METHOD FOR UPLOADING AND DOWNLOADING FILE, AND SERVER FOR EXECUTING THE SAME

(71) Applicant: ASD Korea, Seoul (KR)

(72) Inventor: Sun Ung Lee, Seoul (KR)

(21) Appl. No.: 16/243,597

(22) Filed: Jan. 9, 2019

(30) Foreign Application Priority Data
Nov. 12, 2018 (KR) 10-2018-0137915

(51) Int. Cl. H04L 29/08; G06F 16/13

(52) U.S. Cl. CPC H04L 67/10; G06F 16/13

(57) ABSTRACT

A method for uploading and downloading file includes receiving, by a request receiver of the server, an upload request of a file from a first user terminal; transmitting, by the request receiver, a location information of a storage for storing the file to the first user terminal, verifying, by an upload confirmer of the server, whether the file is uploaded to the storage by the first user terminal, and storing, by a DB manager of the server, a metadata of the file including the location information in a metadata database (DB) when the file is uploaded to the storage by the first user terminal. A user may directly upload/download a file to/from the storage through the user terminal, and in this case, even if the number of users is increased, the server may not directly upload/download the file, thereby minimizing load burden of the server.

### CROSS-REFERENCE TO RELATED APPLICATION(S)

This application claims the benefit under 35 USC § 119(a) of Korean Patent Application No. 10-2018-0137915, filed on Nov. 12, 2018, in the Korean Intellectual Property Office, the entire disclosure of which is incorporated herein by reference for all purposes.

### BACKGROUND

### 1. Field

The following description relates to a technology for uploading and downloading files.

### 2. Description of Related Art

As the network technology develops, data stored in a user terminal (e.g., a desktop computer, a notebook computer, a portable device, etc.) may be stored in a storage through a server on the cloud, and the user may upload or download a file through the server. Also, the user may check a modified file through file sharing and file synchronization in real time. In general, a provider providing a cloud service such as file upload/download, file sharing, file synchronization, manages the storage in which an actual physical file is stored as well as the server, and when a user requests uploading/downloading of a file, the server uploads/downloads the file to/from the storage. However, as the cloud service is processed through the server, when the upload/download request of thousands to hundreds of users is concentrated in the server, the server-side load is excessively increased.

In addition, in the related art, the server stores the actual physical file and the metadata of the file in the storage at the same time without distinguishing the actual physical file and the metadata of the file, in this case, various problems such as errors, conflicts, delay, frequently occur when the file is managed, the file is shared, and synchronization is performed. In general, a file sharing operation, a file synchronization operation, and the like are performed in a manner of comparing or verifying metadata of a file such as a name, a version, modification dates/generation dates, and a storage location of a file. As the size of the metadata is not large, a time required for calculation such as comparison, verification, and the like is very short. On the other hand, an operation such as uploading and downloading of the physical file may take long time when the size of the file itself is large. In the related art, as the physical file and metadata of the file are managed in one storage, an error or collision occurs when several users simultaneously change files while the files are being uploaded/downloaded and a delay of file sharing and file synchronization occurs with frequency due to uploading/downloading of the file.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to improve work efficiency such as file management, file sharing, file synchronization, by minimizing a server-side load by allowing a user to upload/download a file directly to a storage and managing the file and metadata of the file through different paths.

In one general aspect, there is provided a server operated by a first operator and connected to one or more storages operated by a second operator which is different from the first operator and a plurality of user terminals respectively through a network, wherein the server comprises: a request receiver configured to receive an upload request of a file from a first user terminal and transmit a location information of a storage for storing the file to the first user terminal; an upload confirmer configured to verify whether the file is uploaded to the storage by the first user terminal; and a DB manager configured to store a metadata of the file including the location information in a metadata database (DB) when the file is uploaded to the storage by the first user terminal.

The metadata DB may be distinguished from the storage and may be operated by the first operator.

The metadata DB may include a plurality of nodes, and the DB manager may store the metadata in each of the plurality of nodes in a form of a block chain.

The request receiver may receive a download request of the file from a second user terminal, retrieve metadata corresponding to the file from the metadata DB by using file information included in the download request, and transmit the location information of the storage included in a retrieved metadata to the second user terminal.

In another general aspect, there is provided a method for uploading and downloading files, which is executed by a server operated by a first operator and connected to one or more storages operated by a second operator which is different from the first operator and a plurality of user terminals respectively through a network, the method comprising: receiving, by a request receiver of the server, an upload request of a file from a first user terminal, transmitting, by the request receiver, a location information of a storage for storing the file to the first user terminal; verifying, by an upload confirmer of the server, whether the file is uploaded to the storage by the first user terminal; and storing, by a DB manager of the server, a metadata of the file including the location information in a metadata database (DB) when the file is uploaded to the storage by the first user terminal.

The metadata DB may be distinguished from the storage and may be operated by the first operator.

The metadata DB may comprise a plurality of nodes, and the storing of the metadata in the metadata DB may comprise storing the metadata in each of the plurality of nodes in a form of a block chain.

After the storing of the metadata in the metadata DB, the method for uploading and downloading files further comprising: receiving a download request of the file from a second user terminal; retrieving metadata corresponding to the file from the metadata DB by using file information included in the download request; and transmitting the location information of the storage included in a retrieved metadata to the second user terminal.

Other features and aspects will be apparent from the following detailed description, the drawings, and the claims.

### BRIEF DESCRIPTION OF THE DRAWINGS

FIG. 1 is a block diagram showing a detailed configuration of a file system according to an exemplary embodiment.

FIG. 2 is a block diagram showing a detailed configuration of a server according to an exemplary embodiment.

FIG. 3 is a flowchart for describing a method for uploading files according to an exemplary embodiment.

FIG. 4 is a flowchart for describing a method for downloading files according to an exemplary embodiment.

FIG. 5 is a block diagram for describing a computing environment including a computing device suitable for use in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

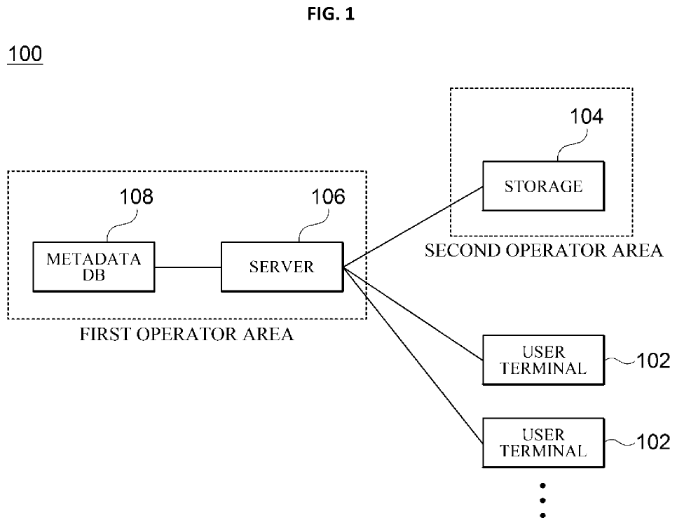

FIG. 1 is a block diagram of a file system 100 according to an exemplary embodiment. As shown in FIG. 1, a file system 100 according to an exemplary embodiment includes a plurality of user terminals 102, one or more storages 104, a server 106, and a metadata database (DB) 108.

The user terminal 102 may be a terminal held by a user, for example, a desktop, a notebook, a tablet computer, a smart phone, a PDA, a smart watch, and the like. The user terminal 102 may request the server 106 to upload or download a file according to a user command. In this case, the user terminal 102 may directly access the storage 104 and upload or download a file, unlike the related art.

As an example, the user terminal 102 may request uploading the file to the server 106, receive location information of the storage 104 to which the file is to be uploaded from the server 106, and directly access the storage 104 using the location information. Here, the location information of the storage 104 may be, for example, an IP address, a uniform resource locator (URL) of the storage 104. The user terminal 102 may access the storage 104 with reference to the location information of the storage 104 received from the server 106 and then directly upload the file to the storage 104.

As another example, the user terminal 102 may request downloading the file to the server 106, receive the location information of the storage 104 in which the file is stored from the server 106, and then directly access the storage 104 using the location information. The user terminal 102 may access the storage 104 with reference to the location information of the storage 104 received from the server 106 and then directly download the file from the storage 104.

The storage 104 is a repository in which files are stored. The file stored in the storage 104 may be a physical file. As will be described later, metadata such as the name, version, date of modification/creation, and storage location of the file is not stored in the storage 104 but is stored in a metadata DB 108 distinguished from the storage 104. Although only one storage 104 is illustrated in FIG. 1 for convenience of explanation, a plurality of storages 104 may exist according to an exemplary embodiment.

The server 106 provides a cloud service such as file upload/download, file sharing, file synchronization, and the like. The server 106 may be connected to one or more storages 104 and a plurality of user terminals 102 via a network (not shown), respectively. Here, the network may include the internet, one or more local area networks, wide area networks, cellular networks, mobile networks, other types of networks, or a combination of these networks. Although FIG. 1 illustrates that the server 106 and the metadata DB 108 are separate components for convenience of explanation, the metadata DB 108 may be a component of the server 106.

According to an exemplary embodiment, the server 106 allows a user to upload/download files directly to/from the storage 104 when a file upload or download request of the user terminal 102 is requested, and manages the file and metadata of the file through different paths.

Specifically, the server 106 receives the upload request of the file from the user terminal 102, and transfers the location information of the storage 104 for storing the file to the user terminal 102 according to the reception of the upload request. In this case, the upload request may include file information such as a file name, a version, and a size of the file. The user terminal 102 may receive the location information of the storage 104 from the server 106, access to the storage 104 through the location information, and upload the file directly to the storage 104.

The server 106 may then receive an upload confirmation request of the file from the user terminal 102 and forward the upload confirmation request to the storage 104. The upload confirmation request transmitted from the user terminal 102 may include identification information of the user terminal 102, file information, and the like, and the server 106 may identify the storage 104 to which the upload request is to be transmitted using the identification information, file information, and the like. The server 106 may receive a confirmation response message that the file has been uploaded normally from the storage 104, and generate metadata of the file based on the file information received from the user terminal 102. In this case, the server 106 may insert location information of the storage 104 in which the file is stored into the metadata, and may store metadata including the location information in the metadata DB 108.

Also, the server 106 may receive a download request of a file from the user terminal 102, and retrieve metadata corresponding to the file in the metadata DB 108 using file information included in the download request. The server 106 may receive the retrieved metadata from the metadata DB 108, and may transfer the location information of the storage 104 included in the metadata to the user terminal 102. Thereafter, the user terminal 102 may access the storage 104 with reference to the location information of the storage 104 received from the server 106, and may directly download the file from the storage 104. As described above, according to an exemplary embodiment, a path of the actual physical file and metadata of the file may be completely separated to separately manage two traffics. In this case, an error or a collision, a delay phenomenon, or the like, occurred during uploading/downloading of the file may be minimized. In addition, according to an exemplary embodiment, a user may directly upload/download files to/from the storage 104 through the user terminal 102. In this case, even if the number of users is increased, the server 106 does not directly upload/download files, thereby minimizing load burden of the server 106.

The metadata DB 108 is a place where metadata of a file stored in the storage 104 is stored. In the present exemplary embodiments, the metadata may be, for example, a name, a version, a date of modification/creation, a storage location of files, identification information of the user who uploaded files or the user terminal 102. In this case, the metadata DB 108 may include a plurality of nodes, and the server 106 may store the metadata in each of the plurality of nodes in the form of a blockchain. Here, each node may be a hardware device having a predetermined storage space. That is, according to an exemplary embodiment, the metadata of the file is stored in each node connected by the blockchain, thereby ensuring integrity of the metadata and preventing the metadata stored in the metadata DB 108 from being arbitrarily modified by an unauthorized person.

The metadata DB 108 may include a plurality of shards, and the server 106 may distribute and store a large amount of metadata to the plurality of shards. For example, metadata of the file uploaded by the user terminal 102 #1 to user terminal 102 #10 may be stored in the first shard, metadata of the file uploaded by the user terminal 102 #11 to user terminal 102 #20 may be stored in the second shard, and metadata of the file uploaded by the user terminal 102 #21 to user terminal 102 #30 may be stored in the third shard. That is, each shard may be mapped to a group to which a specific user terminal 102 or a set two or more user terminals 102 belong, and the server 106 may identify a shard to store the metadata by referring to identification information of the user terminal 102 included in the metadata.

In addition, in the present embodiments, the server 106 and the metadata DB 108 may be operated by a first operator, and the storage 104 may be operated by a second operator that is different from the first operator. Here, the first operator may be, for example, a provider providing a cloud service, a provider providing a blockchain service, and the like, and may be a business who is relatively superior to a second operator to be described later. Also, the second business operator may be, for example, a storage related expert (e.g., Amazon, Google, etc.). That is, the server 106, the metadata DB 108, and the storage 104 may be operated by different operating entities. Generally, it is difficult to efficiently manage a storage having a large capacity in the case of a business provider, and it is difficult to recover data due to a lack of experts when an error occurs in the storage. Accordingly, the first operator may put the physical file, which has a relatively large size compared to the metadata, on a second provider, which is a storage related professional. In this case, a large amount of files may be more easily backed up and a file may be quickly and rapidly recovered when an error occurs in the storage 104. In addition, in this case, the storage 104 may be easily replaced, and various types of storage 104 that are suitable for a user may be simultaneously employed.

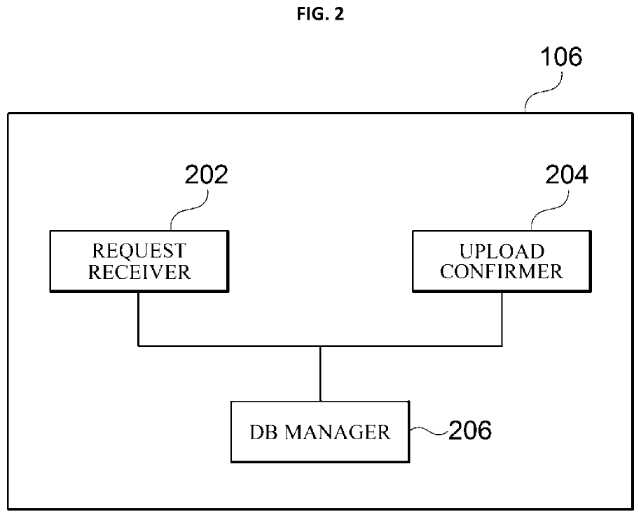

FIG. 2 is a block diagram illustrating a detailed configuration of the server 106 according to an exemplary embodiment. Referring to FIG. 2, the server 106 includes a request receiver 202, an upload confirmer 204, and a DB manager 206.

The request receiver 202 receives an upload request of the file from the user terminal 102, and transmits the location information of the storage 104 to store the file to the user terminal 102 according to the reception of the upload request. In this case, the upload confirmation request transmitted from the user terminal 102 may include identification information and file information of the user terminal 102, and the server 106 may identify the storage 104 to which the upload request is to be transmitted using the identification information, file information, and the like.

The request receiver 202 may receive a download request of the file from the user terminal 102. In this case, the request receiver 202 may retrieve metadata corresponding to the file from the metadata DB 108 using the file information included in the download request, and may transfer the location information of the storage 104 included in the retrieved metadata to the user terminal 102.

The upload confirmer 204 receives a request for uploading the file from the user terminal 102, and determines whether the file is uploaded to the storage 104 by the user terminal 102 according to the reception of the upload confirmation request. The user terminal 102 may receive location information of the storage 104 for storing the file from the request receiver 202, and upload the file to the storage 104 using the location information. After uploading the file, the user terminal 102 may transmit a request message for confirming whether the upload of the file has been normally performed to the upload confirmer 204. Accordingly, the upload confirmer 204 may check whether the file is uploaded to the storage 104 by the user terminal 102. For example, the upload confirmer 204 may check whether the file is completely uploaded by using a hash value of the uploaded file. However, this is merely an example, and a method of checking whether the upload confirmer 204 completes uploading of files is not particularly limited.

When the file is identified as being uploaded to the storage 104 by the user terminal 102, the DB manager 206 stores metadata of a file including location information of the storage 104 in the metadata DB 108. As described above, the metadata DB 108 may include a plurality of nodes, and the DB manager 206 may store the metadata in the plurality of nodes in the form of a blockchain.

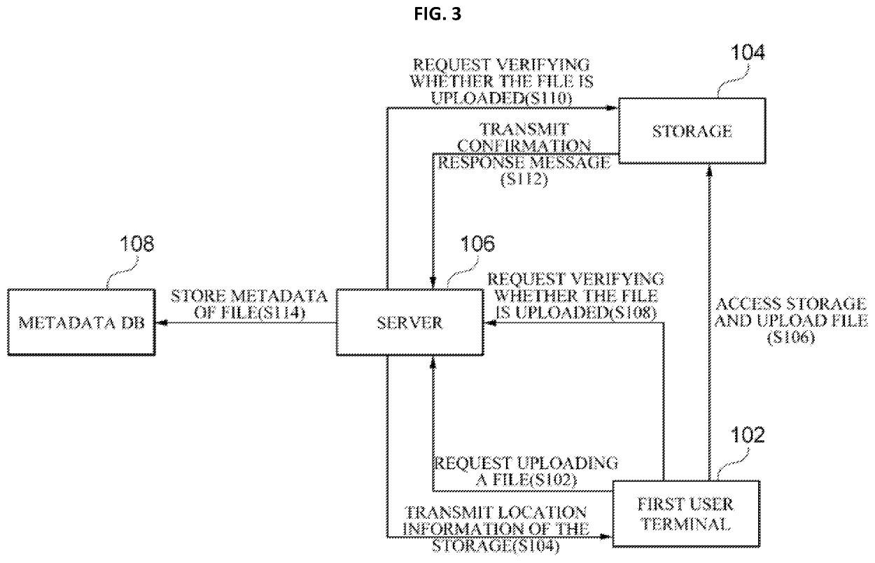

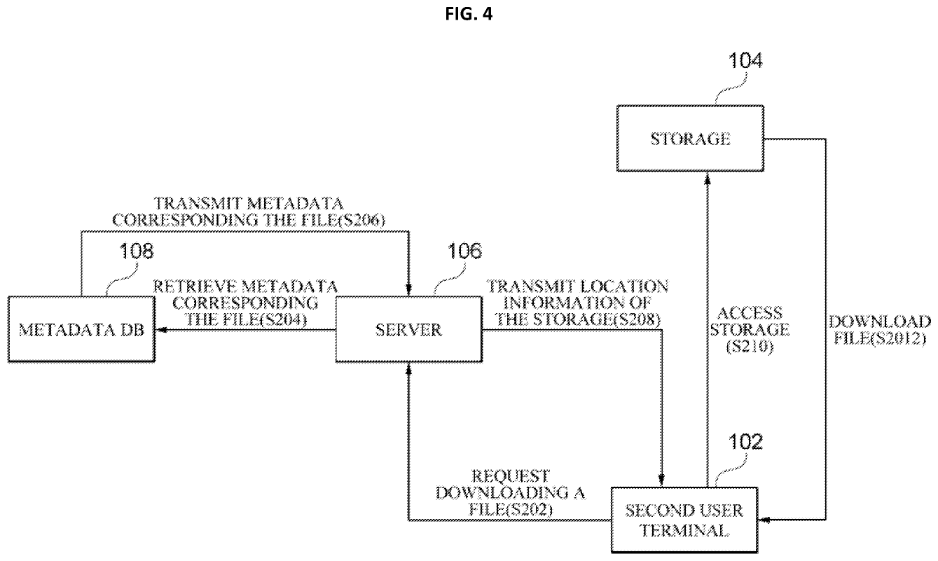

FIG. 3 is a flowchart illustrating an uploading method of a file according to an exemplary embodiment. In the illustrated flow chart, the method is described by dividing the method into a plurality of steps, but at least some steps may be performed by changing an order, by being combined with another step, or by being omitted, or by being divided into detailed steps. For convenience of description, it is assumed in FIG. 3 that the first user terminal 102 uploads a file, and in FIG. 4, the second user terminal 102 that is different from the first user terminal 102 downloads the file. However, this is merely an example, and the user terminal 102 uploading the file may download the uploaded file again.

In S102, the first user terminal 102 requests uploading a file to the server 106.

In S104, the server 106 transmits the location information of the storage 104 for storing the file to the first user terminal 102.

In S106, the first user terminal 102 accesses the storage 104 using the location information and uploads the file to the storage 104.

In S108, the first user terminal 102 requests verifying whether the file is uploaded to the server 106.

In S110, the server 106 requests verifying whether the file is uploaded to the storage 104.

In S112, the storage 104 checks whether the file is normally uploaded, and transmits a confirmation response message indicating that the file is normally uploaded to the server 106.

In S114, the server 106 stores metadata of a file including location information of the storage 104 in the metadata DB 108.

FIG. 4 is a flowchart illustrating a method of downloading a file according to an exemplary embodiment.

In S202, the second user terminal 102 requests downloading a file to the server 106. The download request of the second user terminal 102 may include file information such as a name, a version, and a size of a file to be downloaded.

In S204, the server 106 retrieves metadata corresponding to the file from the metadata DB 108 using the file information included in the download request.

In S206, the server 106 receives the metadata retrieved from the metadata DB 108, and extracts location information of the storage 104 storing the file from the metadata.

In S208, the server 106 transmits the location information of the storage 104 included in the metadata to the second user terminal 102.

In S210, the second user terminal 102 accesses the storage 104 using the location information.

In S212, the second user terminal 102 downloads the file from the storage 104.

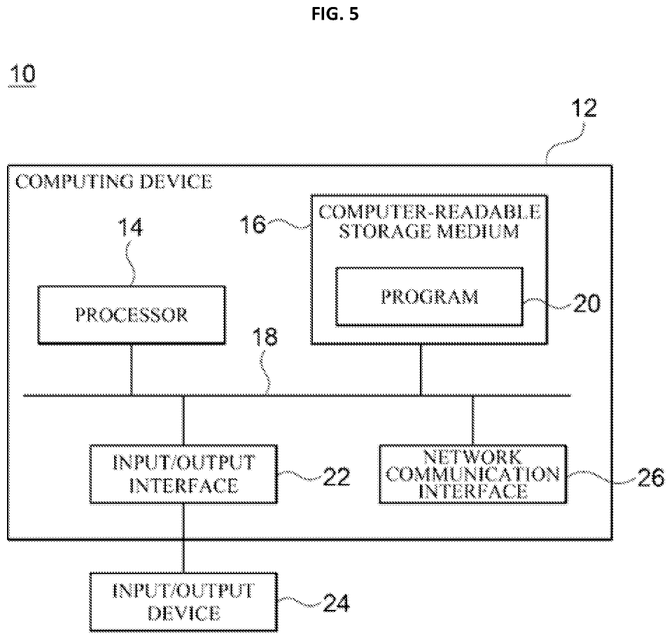

FIG. 5 is a block diagram illustrating a computing environment including a computing device suitable for use in exemplary embodiments. In the illustrated embodiment, each component may have different functions and capabilities than those described below, and may include additional components as well as those described below.

The computing environment 10 includes a computing device 12. In one embodiment, computing device 12 may be a file system 100 or one or more components included in file system 100.

Computing device 12 includes at least one processor 14, a computer-readable storage medium 16 and a communication bus 18. The processor 14 may allow the computing device 12 to operate according to the above-described exemplary embodiments. For example, the processor 14 may execute one or more programs stored in the computer-readable storage medium 16. The one or more programs may include one or more computer-executable instructions, and the computer executable instructions may be configured to cause the computing device 12 to perform operations according to an exemplary embodiment when executed by the processor 14.

The computer-readable storage medium 16 is configured to store computer-executable instructions, program code, program data, and/or other suitable types of information. The program 20 stored in the computer-readable storage medium 16 includes a set of instructions executable by the processor 14. In an embodiment, the computer-readable storage medium 16 may be a memory (volatile memory such as random access memory, non-volatile memory, or any suitable combination thereof), one or more magnetic disk storage devices, optical disk storage devices, flash memory devices, other types of storage media that are accessible by the computing device 12 and that can store desired information, or a suitable combination thereof.

The communication bus 18 includes a processor 14, a computer-readable storage medium 16, to interconnect other various components of the computing device 12.

Computing device 12 may also include one or more input/output interfaces 22 and one or more network communication interfaces 26 that provide an interface for one or more input/output devices 24. The I/O interface 22 and the network communication interface 26 are connected to a communication bus 18. The I/O device 24 may be connected to other components of the computing device 12 through the I/O interface 22. The input/output device 24 may include an input device such as a pointing device (e.g., a mouse or a track pad), a keyboard, a touch input device (e.g., a touch pad or a touch screen), a voice or sound input device, various types of sensor devices, an input device such as a photographing device, and/or an output device such as a display device, a printer, a speaker, and/or a network card. The exemplary input/output device 24 may be included within the computing device 12 as a component that configures the computing device 12, or may be coupled with the computing device 12 as a separate device that is distinct from the computing device 12.

Although the exemplary embodiment of the present invention has been described in detail with reference to the exemplary embodiment of the present invention, it will be understood by those skilled in the art that various modifications may be made within the scope of the present invention. Therefore, the scope of the present invention should not be limited to the described embodiments, and should be determined by the appended claims as well as the appended claims.

What is claimed is:

1. A server operated by a first operator and connected to one or more storages operated by a second operator which is different from the first operator and a plurality of user terminals respectively through a network, wherein the server comprises:
a request receiver configured to receive an upload request of a file from a first user terminal and transmit a location information of a storage for storing the file to the first user terminal;
an upload confirmer configured to verify whether the file is uploaded to the storage by the first user terminal; and
a database (DB) manager configured to store a metadata of the file including the location information in a metadata database (DB) when the file is uploaded to the storage by the first user terminal.

2. The server of claim 1, wherein the metadata DB is distinguished from the storage and operated by the first operator.

3. The server of claim 1, wherein the metadata DB includes a plurality of nodes, and the DB manager stores the metadata in each of the plurality of nodes in a form of a block chain.

4. The server of claim 1, wherein the request receiver receives a download request of the file from a second user terminal, retrieves metadata corresponding to the file from the metadata DB by using file information included in the download request, and transmits the location information of the storage included in a retrieved metadata to the second user terminal.

5. A method for uploading and downloading files, which is executed by a server operated by a first operator and connected to one or more storages operated by a second operator which is different from the first operator and a plurality of user terminals respectively through a network, the method comprising:
receiving, by a request receiver of the server, an upload request of a file from a first user terminal,
transmitting, by the request receiver, a location information of a storage for storing the file to the first user terminal;
verifying, by an upload confirmer of the server, whether the file is uploaded to the storage by the first user terminal; and
storing, by a database (DB) manager of the server, a metadata of the file including the location information in a metadata database (DB) when the file is uploaded to the storage by the first user terminal.

6. The method of claim 5, wherein the metadata DB is distinguished from the storage and operated by the first operator.

7. The method of claim 5, wherein the metadata DB comprises a plurality of nodes, and the storing of the metadata in the metadata DB comprises storing the metadata in each of the plurality of nodes in a form of a block chain.

8. The method of claim 5, further, after the storing of the metadata in the metadata DB, comprising:
receiving a download request of the file from a second user terminal;
retrieving metadata corresponding to the file from the metadata DB by using file information included in the download request; and
transmitting the location information of the storage included in a retrieved metadata to the second user terminal.
